(19) United States
(12) Patent Application Publication
(10) Pub. No.: US 2024/0213461 A1
(43) Pub. Date: Jun. 27, 2024

(54) BIPOLAR ELECTRODE FOR METAL HYDRIDE BATTERY, METAL HYDRIDE BATTERY EQUIPPED WITH BIPOLAR ELECTRODE, METHOD FOR PRODUCING BIPOLAR ELECTRODE FOR METAL HYDRIDE BATTERY, AND METHOD FOR PRODUCING METAL HYDRIDE BATTERY

(71) Applicants: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(72) Inventors: Yuki CHUJO, Kariya-shi (JP); Tomohiro NAKAMURA, Kariya-shi (JP); Kyohei MATSUURA, Kariya-shi (JP); Yutaro KAWABATA, Kariya-shi (JP); Takayuki HIROSE, Kariya-shi (JP); Motoaki OKUDA, Kariya-shi (JP); Takeo OKANISHI, Kariya-shi (JP); Motoyoshi OKUMURA, Nagoya-shi (JP); Hiroyuki KAIYA, Toyota-shi (JP); Masashi KODAMA, Hadano-shi (JP); Daiki TERASHIMA, Okazaki-shi (JP); Masanobu OUCHI, Toyota-shi (JP); Koh YOSHIOKA, Kudamatsu-shi (JP); Shinichirou HORIE, Kudamatsu-shi (JP); Toshifumi KOYANAGI, Kudamatsu-shi (JP)

(73) Assignees: KABUSHIKI KAISHA TOYOTA JIDOSHOKKI, Kariya-shi, Aichi-ken (JP); TOYOTA JIDOSHA KABUSHIkI KAISHA, Toyoda-shi, Aichi-ken (JP)

(21) Appl. No.: 18/288,255

(22) PCT Filed: Apr. 27, 2022
(86) PCT No.: PCT/JP2022/019056

§ 371 Date: Oct. 25, 2023

(30) Foreign Application Priority Data
Apr. 28, 2021 (JP) 2021-076896

(51) Int. Cl. H01M 4/38; H01M 4/24; H01M 4/28; H01M 4/66; H01M 10/34; H01M 4/02

(52) U.S. Cl. CPC H01M 4/383; H01M 4/242; H01M 4/28; H01M 4/661; H01M 4/667; H01M 4/669; H01M 10/345; H01M 2004/029

(57) ABSTRACT

A bipolar electrode (100) for a metal hydride battery includes a current collector (10), a negative electrode active material layer (20) provided on a first surface (10A) of the current collector (10), and a positive electrode active material layer (30) provided on a second surface (10B) of the current collector (10). The negative electrode active material layer (20) contains a metal hydride. The current collector (10) includes a steel sheet (13) and a Ni—Fe alloy layer (15) formed on at least one surface of the steel sheet (13).

### TECHNICAL FIELD

The present disclosure relates to a bipolar electrode for a metal hydride battery, a metal hydride battery including a bipolar electrode, a method for producing a bipolar electrode for a metal hydride battery, and a method for producing a metal hydride battery.

### BACKGROUND ART

A metal hydride battery is typically a rechargeable battery including, for example, a positive electrode containing a hydroxide of nickel, such as nickel hydroxide, as a positive electrode active material, a negative electrode containing a hydrogen storage alloy as a negative electrode active material, and an electrolytic solution composed of an alkali metal aqueous solution.

As a conventional power storage module, a bipolar battery is known that includes a bipolar electrode in which a positive electrode is formed on one surface of an electrode plate and a negative electrode is formed on the other surface (see the following Patent Literature 1, for example). The bipolar battery includes a stack in which the bipolar electrode and a separator are alternately stacked in a stacking direction. On each of opposite ends of the stack in the stacking direction, a terminal electrode having only one of the positive electrode or the negative electrode is positioned. An electrolytic solution is contained in an internal space formed between the electrodes.

### CITATION LIST

### Patent Literature (Non-Patent Literature)

Patent Literature 1: Japanese Laid-Open Patent Publication No. 2005-135764

### SUMMARY OF INVENTION

### Technical Problem

For a current collector forming a bipolar electrode for a metal hydride battery, a plated steel sheet is used from the viewpoints of cost and resistance against reactivity with an electrolytic solution. When the present inventors produced a bipolar electrode using a current collector composed of a plated steel sheet, a negative electrode containing a hydrogen storage alloy, and a positive electrode, and assembled a hydride battery using this bipolar electrode to perform a storage test, a voltage drop (self-discharge) phenomenon of unknown cause was observed.

### Solution to Problem

The present inventors made intensive investigation, and consequently considered that a phenomenon of hydrogen moving toward a counter electrode through the current collector of the bipolar electrode was involved with the self-discharge, and conceived of an idea of reducing hydrogen permeation with a layer containing a specific material. Accordingly, the present inventors found that the self-discharge would be reduced by using a current collector including a layer containing a specific material.

A bipolar electrode for a metal hydride battery according to an aspect of the present disclosure includes a current collector including a first surface and a second surface opposite to the first surface, a negative electrode active material layer provided on the first surface, and a positive electrode active material layer provided on the second surface. The negative electrode active material layer contains a metal hydride. The current collector includes a steel sheet and a Ni—Fe alloy layer formed on at least one surface of opposite surfaces of the steel sheet.

### BRIEF DESCRIPTION OF DRAWINGS

FIG. 1A is a schematic diagram illustrating a cross section of a bipolar electrode for a metal hydride battery of the present embodiment.

FIG. 1B is a schematic diagram illustrating a cross section of a bipolar electrode for a metal hydride battery of the present embodiment.

FIG. 2 is a schematic diagram showing an example of results obtained by SEM-EDX (energy dispersive X-ray spectrometry) of a Ni—Fe alloy layer.

FIG. 3 is an explanatory diagram of an electrochemical hydrogen permeation method.

FIG. 4 is a diagram showing evaluation results of an effect of inhibiting hydrogen permeation.

FIG. 5A is a schematic diagram illustrating a cross section of a bipolar electrode for a metal hydride battery of another embodiment.

FIG. 5B is a schematic diagram illustrating a cross section of a bipolar electrode for a metal hydride battery of another embodiment.

FIG. 5C is a schematic diagram illustrating a cross section of a bipolar electrode for a metal hydride battery of another embodiment.

FIG. 6 is a schematic cross-sectional view illustrating an example of a power storage device for which a bipolar electrode for a metal hydride battery of the present embodiment is applied.

FIG. 7 is a schematic cross-sectional view illustrating an inner construction of the power storage module in FIG. 6.

FIG. 8 is a schematic diagram of a battery for evaluation for which a bipolar electrode for a metal hydride battery of the present embodiment is applied.

### DESCRIPTION OF EMBODIMENTS

Hereinafter, a bipolar electrode for a metal hydride battery of an embodiment of the present disclosure and a metal hydride battery will be described in order. In addition, a method that produces this bipolar electrode for a metal hydride battery and a method that produces a metal hydride battery using this bipolar electrode for a metal hydride battery will be described in detail in order.

Hereinafter, the method that produces the bipolar electrode for a metal hydride battery of the present disclosure may be referred to as “the electrode production method of the present disclosure” as necessary. The method that produces the metal hydride battery of the present disclosure may be referred to as “the battery production method of the present disclosure”. The bipolar electrode for a metal hydride battery of the present disclosure may be referred to as “the electrode of the present disclosure” or “the bipolar electrode of the present disclosure”. Unless otherwise specified, a numerical range of x to y described herein includes the lower limit x and the upper limit y within the range. Any combination of these upper limit values and lower limit values as well as values listed in Examples may be used to define a numerical range. Furthermore, any values selected from a numerical range can be set to be values of an upper limit or a lower limit.

### Bipolar Electrode for Metal Hydride Battery: First Embodiment

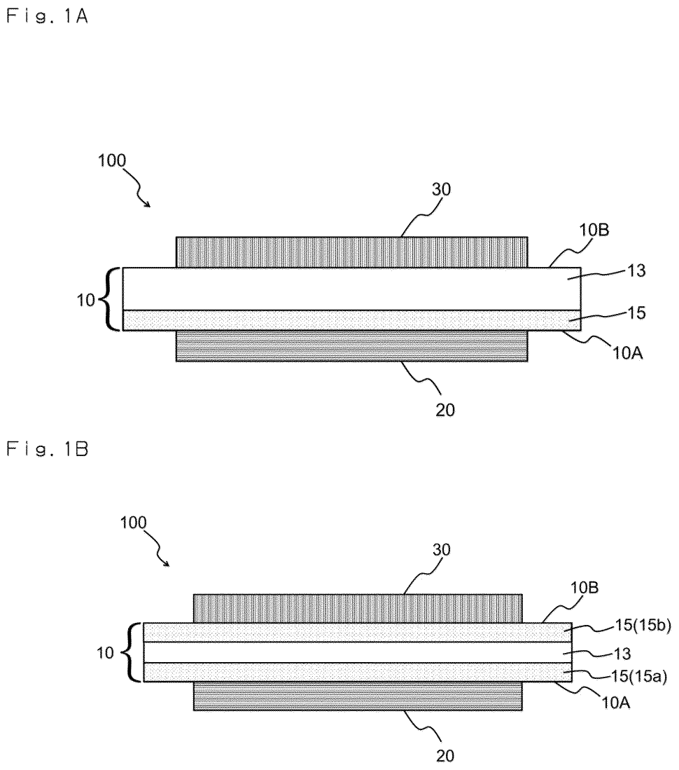

First, the bipolar electrode for a metal hydride battery of the present disclosure will be described in detail by using the following embodiments and drawings. As illustrated in FIG. 1A, a bipolar electrode 100 for a metal hydride battery of the present embodiment includes a current collector 10, a negative electrode active material layer 20 provided on a first surface 10A of the current collector 10, and a positive electrode active material layer 30 provided on a second surface 10B different from the first surface 10A of the current collector 10. The negative electrode active material layer 20 contains a metal hydride. The current collector 10 includes a steel sheet 13 and a Ni—Fe alloy layer 15 provided on at least one surface of the steel sheet 13.

The bipolar electrode 100 basically includes a negative electrode active material (a metal hydride) on the first surface 10A of the current collector 10, and a positive electrode active material on the second surface 10B opposite to the first surface 10A, but the configuration is not limited thereto. That is, regarding the electrode of the present disclosure, a first current collector including a metal hydride and a second current collector including a positive electrode active material may be bonded to form a bipolar electrode.

The current collector 10 includes the Ni—Fe alloy layer 15 on the surface of the steel sheet 13. Examples of the steel sheet 13 include carbon steel such as low-carbon steel with a carbon content of less than 0.25% by weight, ultralow-carbon steel with a carbon content of less than 0.01% by weight, and non-aging ultralow-carbon steel in which Ti, Nb, and the like are added to an ultralow-carbon steel. Examples of the low-carbon steel include low-carbon aluminum killed steel (carbon content: 0.01 to 0.15% by weight) and a cold rolled steel sheet (such as SPCC) prescribed in JIS G 3141:2005. The low-carbon aluminum killed steel (carbon content: 0.01 to 0.15% by weight) is preferably adopted in terms of rollability and economy. A main material of the steel sheet 13 is Fe, and metal elements other than Fe may be contained. The proportion of the metal elements other than Fe in the steel sheet 13 is preferably 10% by weight or less, more preferably 5% by weight or less, further preferably 2% by weight or less, and particularly preferably 1% by weight or less. The thickness of the current collector 10 may be in a range of 5 μm to 1000 μm.

The Ni—Fe alloy layer 15 is formed on at least one surface of the steel sheet 13. The Ni—Fe alloy layer 15 is an alloy layer containing an alloy composed of substantially nickel (Ni) and iron (Fe).

The Ni—Fe alloy layer 15 in the present embodiment is not limited as long as it contains nickel (Ni) and iron (Fe), and a state how each component is contained is not particularly limited.

The definition of the Ni—Fe alloy layer herein is as follows. When a portion from a surface layer to a depth of 10 μm is subjected to elemental analysis of Ni and Fe, the Ni—Fe alloy layer is defined to be present in a portion where Ni and Fe are contained at a content of not less than 1/10 of the maximum value of each content of Ni and Fe.

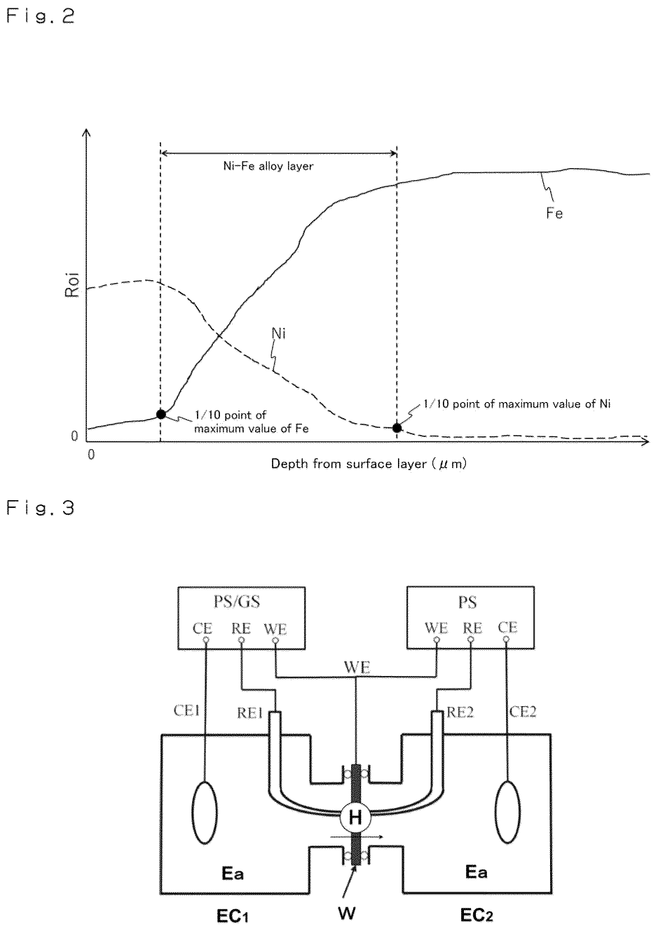

That is, as for the Ni—Fe alloy layer 15 in the present embodiment, readable as the Ni—Fe alloy layer is a distance between a 1/10 point of the maximum value of Ni and a 1/10 point of the maximum value of Fe in a portion near a crossing point of a Ni curve and a Fe curve in results obtained by SEM-EDX (energy dispersive X-ray spectrometry) as shown in FIG. 2. FIG. 2 is an example of the above analysis results, and indicates a distance (μm) in the depth direction from the surface layer as the horizontal axis and X-ray intensities of Ni and Fe as the vertical axis.

In the present embodiment, the metal elements contained in the Ni—Fe alloy layer 15 are not limited to Ni and Fe. The Ni—Fe alloy layer 15 may contain other metal elements as long as the object of the present invention is achieved.

For example, the Ni—Fe alloy layer 15 may contain metal elements such as Co and Mo, or inevitable impurities. The proportion of the metal elements other than Ni and Fe in the Ni—Fe alloy layer 15 is preferably 10% by weight or less, more preferably 5% by weight or less, further preferably 1% by weight or less, and particularly preferably 0.5% by weight or less.

An effect of reducing hydrogen permeation with the Ni—Fe alloy layer 15 in the present embodiment will be described. Specifically, the bipolar electrode for a metal hydride battery of the present embodiment has the effect of reducing hydrogen permeation with the Ni—Fe alloy layer 15 contained in the current collector.

A discharge reaction of a nickel metal hydride battery is represented as follows.

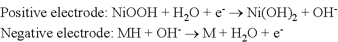

Furthermore, the reaction in the negative electrode includes the following two reactions.

$$\begin{matrix}MH = M + {H}^{+} + {e}^{-} \\ {H}^{+} + O {H}^{-} = {H}_{2} O\end{matrix}$$

During the reaction, electrons e move from the negative electrode to the positive electrode through the current collector in the bipolar electrode. The hydroxide ions OH⁻ move from the positive electrode to the adjacent negative electrode of the bipolar electrode through the electrolytic solution. Outside the battery, the electrons move from the negative electrode to the positive electrode through an external circuit (load).

Meanwhile, when the current collector of the bipolar electrode allows the hydrogen permeation, the following reactions occur in the positive electrode and the negative electrode even without connection to the external circuit.

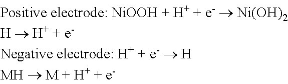

A hydrogen concentration gradient generated between the negative electrode active material layer (metal hydride MH) and the positive electrode active material layer generates hydrogen atoms [H] in the negative electrode active material layer with the above reaction. The hydrogen atoms [H] move from the negative electrode active material layer to the positive electrode active material layer, which is the counter electrode, through the current collector. Since the hydrogen atoms [H] moved to the positive electrode are consumed in the positive electrode as the above reaction formula, the hydrogen concentration gradient is continuously generated between the negative electrode active material layer and the positive electrode active material layer. As a result, this reaction cycle repeatedly occurs to cause a positive electrode potential to continuously drop and a negative electrode potential to continuously rise, which drops the battery voltage. The above reaction, which differs from a reaction occurring in the positive electrode and the negative electrode in normal discharge, results in the same reaction of the active material, and the reaction drops each of the potentials of the positive electrode and the negative electrode. Since hydrogen release with the metal hydride is an endothermic reaction and a higher potential yields higher reactivity of the active material, the above reaction becomes prominent at a high potential and high temperature. In the bipolar electrode, no electron e⁻ moves through the current collector during the reaction.

Accordingly, the present inventors have conceived of an idea of forming a coating that reduces the hydrogen permeation toward the counter electrode on the steel sheet forming the current collector. Specifically, the present inventors have conceived of an idea of forming the Ni—Fe alloy layer on at least one surface of the steel sheet.

A technique of verifying hydrogen brittleness of steel is conventionally known. The hydrogen brittleness of steel is a delayed fracture phenomenon of steel dominated by hydrogen diffusion. The conventional technique is to verify an effect on mechanical properties of steel itself due to hydrogen remaining in the steel.

Meanwhile, the technique of reducing the hydrogen permeation in the steel sheet based on the hydrogen concentration gradient generated between opposite surfaces of the steel sheet like the bipolar electrode of the present disclosure, has not been known. The present inventors made intensive investigation, and consequently found that the hydrogen permeation in the steel sheet which is the current collector material of the bipolar electrode would be reduced by forming the Ni—Fe alloy layer on at least one surface of the steel sheet.

The effect of reducing the hydrogen permeation in the steel sheet with the Ni—Fe alloy layer is evaluated by using an electrochemical hydrogen permeation method as follows. FIG. 3 schematically illustrates a hydrogen permeation tester used for the evaluation.

In the hydrogen permeation tester, two electrolytic baths and EC₂ are disposed facing each other via a test piece W. The electrolytic bath EC₁ on the left side in FIG. 3 is on a cathode side (hydrogen penetration side) and the electrolytic bath EC₂ on the right side is on an anode side (hydrogen detection side). The hydrogen permeation tester generates hydrogen in the electrolytic bath EC1, and detects an anode current when hydrogen permeating the test piece W and reaching the electrolytic bath EC₂ is oxidized. In FIG. 3, RE1 and RE2 represent reference electrodes, CE1 and CE2 represent counter electrodes, and WE represents the test piece W as a working electrode. Each of them is connected to a potentiostat PS and a potentio/galvanostat PS/GS. As the reference electrodes RE1 and RE2, Hg/HgO or a calomel electrode can be used. For the counter electrodes CE1 and CE2, platinum can be used. For the electrolytic solution Ea, an alkaline electrolytic solution containing KOH, NaOH, or LiOH can be used.

A voltage is applied to the counter electrode CEI with the potentio/galvanostat PS/GS so that a potential on the hydrogen penetration side is −0.6 V, −0.45 V, or −0.3 V (vs RHE (reversible hydrogen electrode)) to measure a change in a current on the hydrogen detection side. A potential on the hydrogen detection side is held to +1.45 V (vs RHE). The liquid temperature is held at 65° C., and degassed with N₂ gas during the test. The effect of reducing the hydrogen permeation through the test piece imitating the current collector can be considered by measuring and comparing hydrogen permeation currents of various test pieces W.

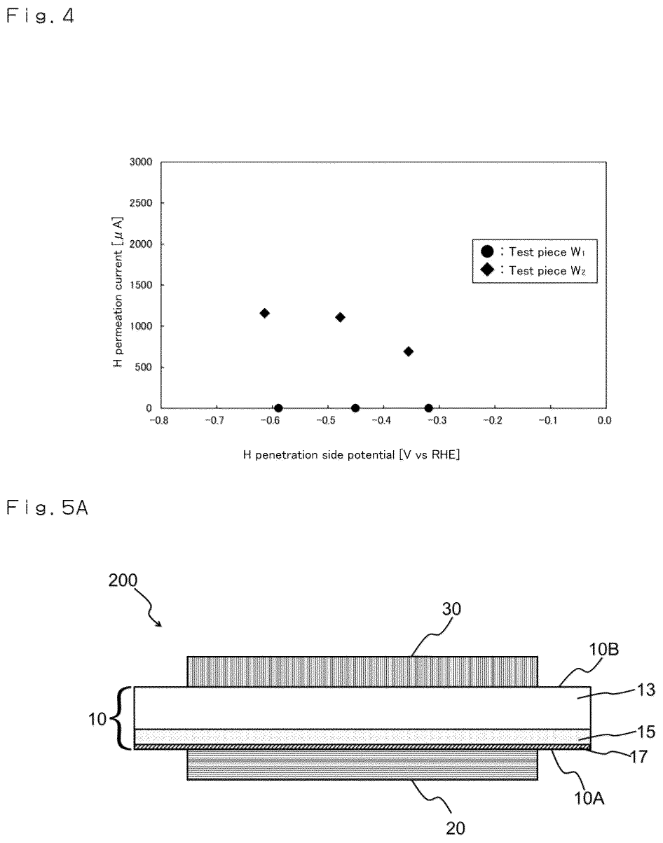

FIG. 4 shows the results of the hydrogen permeation current measured by using the above hydrogen permeation tester and the following two types of test piece.
Test piece W1: A surface-treated steel sheet having Ni plating with a thickness of 5 μm formed on opposite surfaces.
Test piece W2: A surface-treated steel sheet having Ni—Fe alloy layers with a thickness of 3.5 μm formed on opposite surfaces, and further having Ni plating with a thickness of 1 μm formed on the Ni—Fe alloy layer.

For the steel sheet, a cold rolled foil made of low-carbon aluminum killed steel (thickness: 50 μm) is used. Methods for forming the Ni plating layer and the Ni—Fe alloy layer are methods in Example, described later.

Because of the aforementioned phenomenon, the Ni—Fe alloy layer 15 is particularly preferably provided on a surface on a side on which the negative electrode active material layer 20 is positioned of the opposite surfaces of the steel sheet 13.

Because of the aforementioned mechanism for estimating the hydrogen permeation phenomenon, the Ni—Fe alloy layer 15 is preferably provided on at least a surface on a side on which the negative electrode active material layer 20 is positioned of the opposite surfaces of the steel sheet 13, as illustrated in FIG. 1A. That is, the Ni—Fe alloy layer 15 formed between the negative electrode active material layer 20 and the steel sheet 13 inhibits permeation of hydrogen released from the negative electrode active material layer 20 (namely, the hydrogen storage alloy: metal hydride) through the steel sheet 13, which further reduces the hydrogen permeation.

The Ni—Fe alloy layer 15 is further preferably provided on each of the opposite surfaces of the steel sheet 13, as illustrated in FIG. 1B. That is, in FIG. 1B, a Ni—Fe alloy layer 15a is provided on a first surface of the steel sheet 13, and a Ni—Fe alloy layer 15b is provided on a second surface opposite to the first surface. With such a configuration, hydrogen released from the negative electrode active material layer 20 (namely, the hydrogen storage alloy: metal hydride) is predicted to be trapped by the Ni—Fe alloy layer 15b before reaching the positive electrode active material layer 30 if the hydrogen permeates the Ni—Fe alloy layer 15a and the steel sheet 13, and thereby the aforementioned problem of voltage drop is avoided. The first surface of the steel sheet 13 is a surface on the same side as the first surface 10A of the current collector. The opposite surfaces of the steel sheet 13 refer to the first surface and the second surface opposite to the first surface.

The thickness of the Ni—Fe alloy layer 15 is preferably 1.0 μm or more. The Ni—Fe alloy layer 15 having a thickness of 1.0 μm or more is predicted to yield a sufficient effect of reducing the hydrogen permeation with the Ni—Fe alloy layer 15. That is, when the thickness of the Ni—Fe alloy layer 15 in the current collector is 1.0 μm or more, the voltage drop in the battery is predicted to be more effectively reduced.

The thickness of the Ni—Fe alloy layer 15 is further preferably 1.2 μm or more, and more preferably 1.5 μm or more. The Ni—Fe alloy layer 15 is preferably provided on each of the first surface and the second surface of the steel sheet 13.

The thickness of the Ni—Fe alloy layer 15 can be calculated by SEM-EDX (energy dispersive X-ray spectrometry), for example. Specifically, as noted above, a portion from a surface layer to a depth of 10 μm in the thickness direction is subjected to elemental analysis of Ni and Fe with linear analysis with the SEM-EDX (energy dispersive X-ray spectrometry) analysis. The measurement conditions can be set as follows: acceleration voltage: 10 KV, observation magnification: 5000, measurement step: 0.01 μm, and the like. As shown in FIG. 2, readable as the thickness of the Ni—Fe alloy layer from a graph is a distance between a 1/10 point of the maximum value of Ni and a 1/10 point of the maximum value of Fe in a portion near a crossing point of a Ni curve and a Fe curve with setting the distance (μm) in the depth direction from the surface layer as the horizontal axis and X-ray intensities of Ni and Fe as the vertical axis.

The Ni—Fe alloy layer 15 is preferably provided also on a negative electrode terminal electrode, described later. In a cell (unit battery) having the negative electrode terminal electrode, forming the Ni—Fe alloy layer on the negative electrode terminal electrode reduces a decrease in discharge reserve generated due to leakage of hydrogen to an outside of the battery by permeating the negative electrode terminal electrode.

Next, the active material layers (the negative electrode active material layer 20 and the positive electrode active material layer 30) of the present embodiment will be described. In the present embodiment, the negative electrode active material layer 20 contains a negative electrode active material, and as necessary, contains a negative electrode additive, a binder, and a conductive aid. The positive electrode active material layer 30 contains a positive electrode active material, and as necessary, contains a positive electrode additive, a binder, and a conductive aid. Hereinafter, items relating to both of the positive electrode active material layer and the negative electrode active material layer will be collectively described as the active material layers.

In the present embodiment, the negative electrode active material contained in the negative electrode active material layer 20 is not limited as long as it is used as a negative electrode active material of a nickel metal hydride battery, namely a hydrogen storage alloy (metal hydride). The hydrogen storage alloy is basically an alloy between: a metal A easily reacting with hydrogen but having poor releasing ability of hydrogen; and a metal B hardly reacting with hydrogen but having excellent releasing ability of hydrogen. Examples of A include the group 2 elements such as Mg, the group 3 elements such as Sc and lanthanoids, the group 4 elements such as Ti and Zr, the group 5 elements such as V and Ta, a mish metal containing a plurality of rare earth elements (hereinafter, which may be abbreviated as Mm), and Pd. Examples of B include Fe, Co, Ni, Cr, Pt, Cu, Ag, Mn, Zn, and Al.

Specific examples of the hydrogen storage alloy include: an AB₅ type exhibiting a hexagonal CaCu₅-type crystal structure; an AB₂ type exhibiting a hexagonal MgZn₂-type or cubic MgCu₂-type crystal structure; an AB type exhibiting a cubic CsCl-type crystal structure; an A₂B type exhibiting a hexagonal Mg₂Ni-type crystal structure, a solid-solution-type exhibiting a body-centered crystal structure; and an AB₃ type, an A₂B₇ type, and an A₅B₁₉ type in which the ABs₅type and AB₂-type crystal structures are combined. The hydrogen storage alloy may have one of the above crystal structures, or may have two or more of the above crystal structures.

Examples of the AB₅-type hydrogen storage alloy include LaNi₅, CaCu₅, and MmNi₅. Examples of the AB₂-type hydrogen storage alloy include MgZn₂, ZrNi₂, and ZrCr₂. Examples of the AB-type hydrogen storage alloy include TiFe and TiCo. Examples of the A₂B-type hydrogen storage alloy include Mg₂Ni and Mg₂Cu. Examples of the solid-solution-type hydrogen storage alloy include Ti—V, V—Nb, and Ti—Cr. Examples of the AB₃-type hydrogen storage alloy include CeNi₃. Examples of the A₂B₇-type hydrogen storage alloy include Ce₂Ni₇. Examples of the A₅B₁₉-type hydrogen storage alloy include Ce₅Co₁₉ and Pr₅CO₁₉. In each of the crystal structures, a part of the metal may be substituted with other one or more types of metals or elements.

The surface of the negative electrode active material may be treated by a known method. In particular, for the negative electrode active material, a hydrogen storage alloy subjected to an alkali treatment is preferably adopted. The alkali treatment means that the hydrogen storage alloy is treated with an alkaline aqueous solution in which an alkali metal hydroxide is dissolved.

For example, when a hydrogen storage alloy containing a rare earth element and Ni is treated with the alkaline aqueous solution in which the alkali metal hydroxide is dissolved, the rare earth element having high solubility in the alkaline aqueous solution dissolves out of the surface of the hydrogen storage alloy. Since Ni has low solubility in the alkaline aqueous solution, a Ni concentration on the surface of the hydrogen storage alloy consequently becomes higher than that inside of the hydrogen storage alloy. Hereinafter, in the hydrogen storage alloy, a portion having a higher Ni concentration than the inside is referred to as the Ni-concentrated layer. Performance of the negative electrode active material is predicted to be improved by the presence of the Ni-concentrated layer.

Examples of the alkali metal hydroxide include lithium hydroxide, sodium hydroxide, and potassium hydroxide, and sodium hydroxide is particularly preferable. Using a sodium hydroxide aqueous solution as the alkaline aqueous solution may yield preferable battery performance of the nickel metal hydride battery of the present disclosure compared with a case of using lithium hydroxide or potassium hydroxide as the alkaline aqueous solution.

The alkaline aqueous solution is preferably strongly basic. Examples of a concentration of the alkali metal hydroxide in the alkaline aqueous solution include 10 to 60% by mass, 20 to 55% by mass, 30 to 50% by mass, and 40 to 50% by mass.

The alkali treatment is preferably performed by a method of immersing the hydrogen storage alloy in the alkaline aqueous solution. In this case, the alkali treatment is preferably performed under a stirring condition, and preferably performed under a heating condition. Examples of a range of the heating temperature include 50 to 150° C., 70 to 140° C., and 90 to 130° C. The heating time may be appropriately decided according to the concentration of the alkaline aqueous solution and the heating temperature, and examples of the heating time include 0.1 to 10 hours, 0.2 to 5 hours, and 0.5 to 3 hours.

From the viewpoint of the above alkali treatment, the hydrogen storage alloy preferably contains a rare earth element and Ni.

The negative electrode active material is preferably in a powder state. An average particle diameter thereof is preferably within a range of 1 to 100 μm, more preferably within a range of 3 to 50 μm, and further preferably within a range of 5 to 30 μm.

The negative electrode active material layer contains the negative electrode active material at preferably 85 to 99% by mass, more preferably 90 to 98% by mass, relative to a mass of the entire negative electrode active material layer.

The negative electrode additive is added to the negative electrode in order to improve the battery performance of the nickel metal hydride battery. The negative electrode additive is not limited as long as it is used as a negative electrode additive of the nickel metal hydride battery. Specific examples of the negative electrode additive include: fluorides of a rare earth element such as CeF₃ and YF₃; bismuth compounds such as Bi₂O₃ and BiF₃; indium compounds such as In₂O₃ and InF₃; and compounds exemplified as the positive electrode additive.

The negative electrode active material layer contains the negative electrode additive at preferably 0.1 to 10% by mass, and more preferably 0.5 to 5% by mass, relative to the mass of the entire negative electrode active material layer.

A positive electrode active material contained in the positive electrode active material layer 30 of the present embodiment is a hydroxide of nickel used as a positive electrode active material of the nickel metal hydride battery, and a part thereof may be doped with another metal. Specific examples of the positive electrode active material include nickel hydroxide and a metal-doped nickel hydroxide. Examples of the metal for doping into nickel hydroxide include: the group 2 elements such as magnesium and calcium; the group 9 elements such as cobalt, rhodium, and iridium; and the group 12 elements such as zinc and cadmium.

A surface of the positive electrode active material may be treated by a known method. The positive electrode active material is preferably in a powder state. An average particle diameter thereof is preferably within a range of 1 to 100 μm, more preferably within a range of 3 to 50 μm, and further preferably within a range of 5 to 30 μm. The average particle diameter herein means a value of D50 measured by using a common laser diffraction-type particle size distribution meter.

The positive electrode active material layer contains the positive electrode active material at preferably 75 to 99% by mass, more preferably 80 to 97% by mass, further preferably 85 to 95% by mass, relative to the mass of the entire positive electrode active material layer.

The positive electrode additive is added to the positive electrode in order to improve the battery performance of the nickel metal hydride battery. The positive electrode additive is not limited as long as it is used as a positive electrode additive of the nickel metal hydride battery. Specific examples of the positive electrode additive include: niobium compounds such as Nb₂O₅; tungsten compounds such as WO₂, WO₃, Li₂WO₄, Na₂WO₄, and K₂WO₄; ytterbium compounds such as Yb₂O₃; titanium compounds such as TiO₂; yttrium compounds such as Y₂O₃; zinc compounds such as ZnO; calcium compounds such as CaO, Ca(OH)₂, and CaF₂; and other rare earth oxides.

The positive electrode active material layer contains the positive electrode additive at preferably 0.1 to 10% by mass, more preferably 0.5 to 5% by mass, relative to the mass of the entire positive electrode active material layer.

Hereinafter, the binder and the conductive aid, which are contained in the active material layers as necessary, in the present embodiment will be described.

The binder plays a role of binding the active material and the like on the surface of the current collector. The binder is not limited as long as it is used as a binder for an electrode of the nickel metal hydride battery. Specific examples of the binder include: fluorine-containing resins such as polyvinylidene fluoride, polytetrafluoroethylene, and a fluorine rubber; polyolefin resins such as polypropylene and polyethylene; imide resins such as a polyimide and a polyamideimide; cellulose derivatives such as carboxymethylcellulose, methylcellulose, and hydroxypropylcellulose; copolymers such as styrene-butadiene rubber; and (meth)acrylic resins containing a (meth)acrylic acid derivative as a monomer unit, such as polyacrylic acid, a polyacrylate ester, polymethacrylic acid, and a polymethacrylate ester.

The active material layer contains the binder at preferably 0.1 to 15% by mass, more preferably 1 to 10% by mass, further preferably 2 to 7% by mass, relative to the mass of the entire active material layer. This is because an excessively low amount of the binder deteriorates formability of the electrode, and an excessively high amount of the binder decreases an energy density of the electrode.

The conductive aid is added in order to improve conductivity of the electrode. Thus, the conductive aid is optionally added when the conductivity of the electrode is insufficient, and is not necessarily required to be added when the electrode has sufficiently excellent conductivity. The conductive aid may be added to the active material layer in a powder state, or may be used in a state of coating the surfaces of the active material particles. Any conductive aid may be used as long as it is a chemically inert electron conductor. Specific examples of the conductive aid include: metals such as cobalt, nickel, and copper; metal oxides such as cobalt oxide; metal hydroxides such as cobalt hydroxide; and carbon materials such as carbon black, graphite, and carbon fiber.

The negative electrode active material layer 20 contains the conductive aid at preferably 0.1 to 5% by mass, more preferably 0.2 to 3% by mass, further preferably 0.3 to 1% by mass relative to the mass of the entire negative electrode active material layer.

The positive electrode active material layer 30 contains the conductive aid at preferably 0.1 to 10% by mass, more preferably 0.2 to 7% by mass, further preferably 0.3 to 5% by mass relative to the mass of the entire positive electrode active material layer.

### Bipolar Electrode for Metal Hydride Battery: Second Embodiment

Next, the bipolar electrode for a metal hydride battery of the present disclosure will be described in more detail by using the following second embodiment. The present embodiment differs from the aforementioned first embodiment in terms of formation of a Ni layer 17 on at least one of the outermost surfaces of the current collector 10. Thus, these different points will be mainly described, and members having the same functions as the configuration of the aforementioned first embodiment are followed by the same reference number to appropriately omit the description therefor.

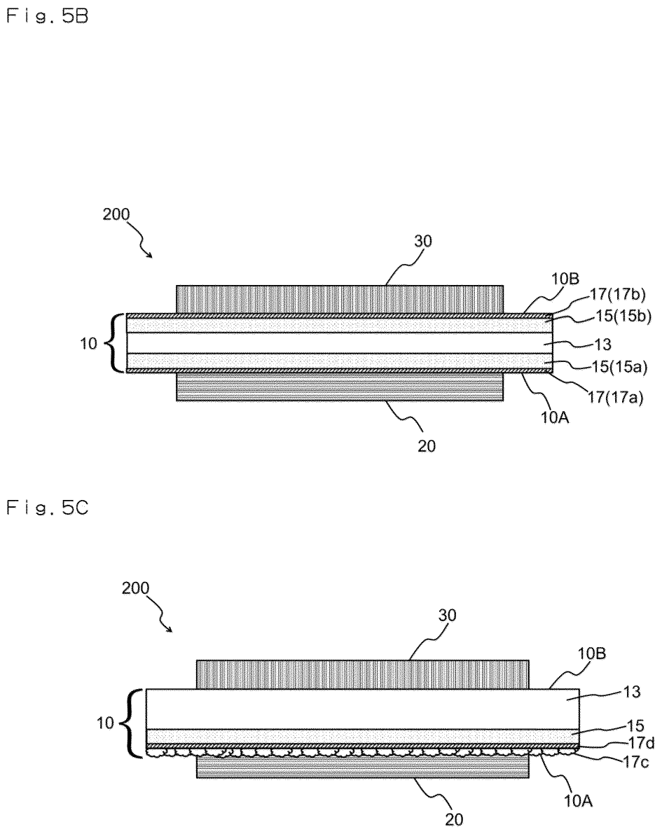

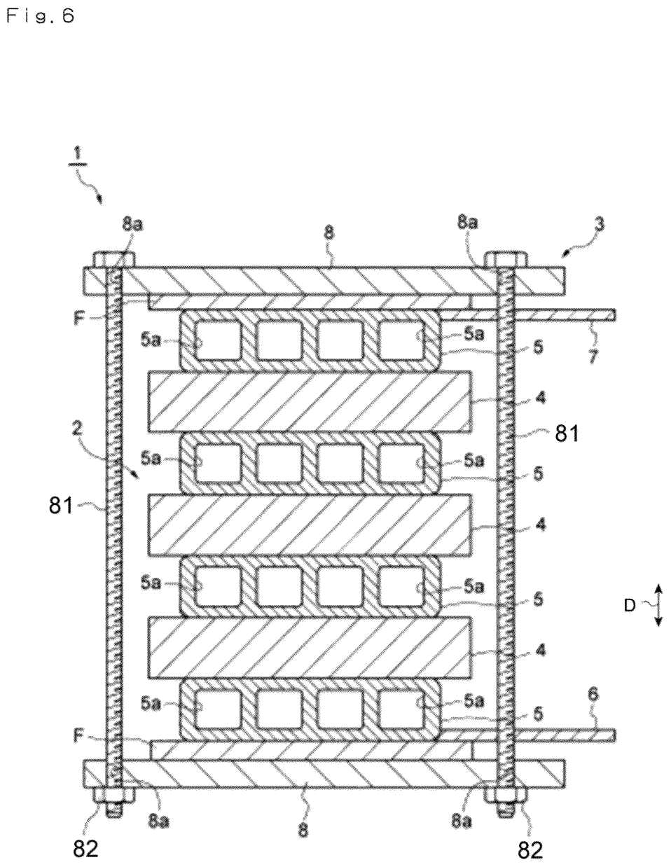

As illustrated in FIG. 5A, in a bipolar electrode 200 for a metal hydride battery of the present embodiment, the Ni layer 17 is formed on the outermost surface on the same side as one surface (a first surface) 10A of the current collector 10. That is, the Ni layer 17 is further formed between the Ni—Fe alloy layer 15 and the negative electrode active material layer 20. As illustrated in FIG. 5B, the present embodiment may have a configuration in which a Ni layer 17a is formed on the outermost surface on the same side as the one surface (the first surface) 10A of the current collector 10 and a Ni layer 17b is formed on the outermost surface of the same side as the other surface (a second surface) 10B. In FIG. 5B, the Ni layer 17a is formed between the Ni—Fe alloy layer 15a and the negative electrode active material layer 20, and the Ni layer 17b is further formed between the Ni—Fe alloy layer 15b and the positive electrode active material layer 30.

The thickness of the Ni layer 17 is not particularly limited, but is preferably 0.1 μm to 10.0 μm, for example.

Metal elements contained in the Ni layer 17 are not limited to Ni, and other metal elements may be contained therein. For example, the Ni layer 17 may contain metal elements such as Co and Mo. A proportion of the metal elements other than Ni in the Ni layer 17 is preferably 10% by weight or less, more preferably 5% by weight or less, further preferably 1% by weight or less, and particularly preferably 0.5% by weight or less.

Examples of a method for forming the Ni layer 17 include: a method of leaving a Ni layer in which Fe is not diffused in a heating treatment for forming the Ni—Fe alloy layer 15 to form the Ni layer 17; and a method of plating Ni again after forming the Ni—Fe alloy layer 15. From the viewpoint of corrosion resistance against the electrolytic solution, the Ni layer 17 is preferably provided by the aforementioned method of plating Ni again, and examples of the plating method include electrolytic plating and electroless plating. Among these methods, the method with electrolytic plating is particularly preferable from the viewpoints of cost, thickness control, and the like.

In the present embodiment, the aforementioned Ni layer 17 may be a roughened Ni layer 17c. The roughened Ni layer 17c means a Ni layer having larger surface roughness than the Ni—Fe alloy layer 15 or the steel sheet 13 on the surface on a side in contact with the negative electrode active material layer 20 or the positive electrode active material layer 30. Changing the Ni layer 17 to the roughened Ni layer 17c improves bonding strength between the current collector 10 and the bonding member. For example, on a bonding interface between the current collector 10 and a sealing portion described later, spaces between multiple protrusions are filled with a resin in a melting state to exhibit an anchor effect. This effect improves the bonding strength between the bipolar electrode of the present embodiment and the sealing portion. Providing the roughened Ni layer 17c increases the surface area, and thereby heat dissipation and the like of the electrode is improved.

A value of the surface roughness of the roughened Ni layer 17c can be represented by using a known parameter and the like. The parameter can be prescribed with a ten-point height of irregularities Rzjis, for example, and the Rzjis is preferably 2.0 μm to 16.0 μm. The ten-point height of irregularities Rzjis is measured in accordance with JIS B 0601:2013, and preferably measured by using a laser microscope.

When the roughened Ni layer 17c is formed, a base Ni layer 17d may be appropriately formed between the Ni—Fe alloy layer 15 and the roughened Ni layer 17c, as illustrated in FIG. 5C. Providing a base Ni layer 17d having a thickness of approximately 0.1 um to 10 μm yields effects such as improvement of adhesiveness to the roughened Ni layer 17c and inhibition of generation of pinholes.

### Method for Producing Bipolar Electrode

Next, a method that produces the bipolar electrode for a metal hydride battery of the present disclosure will be described with the following embodiment. The method for producing a bipolar electrode for a metal hydride battery according to the present embodiment includes: a current collector forming step (step 1); and an active material layer forming step (step 2). The current collector forming step (step 1) includes: a step of providing a Ni layer on at least one surface of a steel sheet (step 1a); and a step of heat-treating the steel sheet on which the Ni layer is provided to diffuse Ni in the Ni layer and Fe in the steel sheet to form a Ni—Fe alloy layer (step 1b). The current collector forming step (step 1) may further include a roughened Ni layer forming step (step 1c). The active material layer forming step (step 2) includes: a step of forming a negative electrode active material layer on a first surface of the current collector (step 2a); and a step of providing a positive electrode active material layer on a second surface of the current collector (step 2b).

The step 1a will be described. The Ni layer is formed on the surface of the steel sheet by, for example, electrolytic plating using a Ni-plating bath. As the Ni-plating bath, a plating bath commonly used for Ni plating, namely a watt bath, a citric acid bath, a sulfamic acid bath, a boron fluoride bath, a chloride bath, and the like can be used. For example, the Ni layer can be formed by using a watt bath with a bath composition of 200 to 350 g/L of nickel sulfate hexahydrate, 20 to 60 g/L of nickel chloride hexahydrate, and 10 to 50 g/L of boric acid, under conditions of a pH of 1.5 to 5.0, a bath temperature of 40 to 80° C., and a current density of 1 to 40 A/dm². The thickness of the Ni layer is preferably 0.05 to 5.0 μm, and more preferably 0.1 to 3.0 μm.

The step 1b will be described. The heating treatment may be performed by any of a continuous annealing method or a box annealing method (bath annealing). The heating treatment conditions may be appropriately selected according to the required thickness of the Ni—Fe alloy layer and the required thickness of the Ni-plating layer. For example, with the continuous annealing method, the heat-treating temperature is preferably within a range of 700 to 800° C. and the heat-treating time is preferably within a range of 10 seconds to 300 seconds. With the box annealing, the heat-treating temperature is preferably within a range of 450 to 600° C., the heat-treating time is preferably within a range of 1 hour to 10 hours, and the heat-treating atmosphere is preferably a non-oxidative atmosphere or a reductive protection gas atmosphere. When the heat-treating atmosphere is the reductive protection gas atmosphere, the used protection gas is preferably a protection gas composed of 75% hydrogen-20% nitrogen generated by an ammonia cracking method, which is a hydrogen-rich annealing with good heat transmission. The heating treatment allows thermal diffusion to form the Ni—Fe alloy layer in which Ni in the Ni layer and Fe in the steel sheet are diffused. In this case, a configuration in which Fe is diffused to reach the surface of the Ni layer is acceptable, and a configuration in which a Ni layer with Fe not diffused remains in a part of the Ni layer is also acceptable.

The step 1c will now be described. Nickel particles are precipitated in an aggregated state by using a method such as electric plating on the Ni—Fe alloy layer formed in the step 1b to form the roughened Ni layer. That is, the roughened Ni layer is present between the Ni—Fe alloy layer and the negative electrode active material layer or the positive electrode active material layer. The roughened Ni layer formed in the step 1c has surface roughness of a surface on the side in contact with the negative electrode active material layer 20 or the positive electrode active material layer 30 formed in the active material layer forming step (step 2), described later. The surface roughness is higher than that of the Ni—Fe alloy layer or the steel sheet. As the method for forming the roughened Ni layer in the step 1c, methods such as sputtering and pressing with a roll having a roughened surface may be applied other than the electric plating. This step 1c may include a step of forming a base Ni layer before forming the roughened Ni layer.

The step 2 will be described. In order to form an active material layer on the surface of the current collector, the active material may be applied on the surface of the current collector using a conventionally known method such as a roll coating method, a die coating method, a dip coating method, a doctor blade method, a spray coating method, and a curtain coating method. Specifically, the active material, a solvent, and as necessary, the binder, the conductive aid, and the additive are mixed to form a slurry, and then this slurry is applied on the surface of the current collector and then dried. Examples of the solvent include N-methyl-2-pyrrolidone, methanol, methyl isobutyl ketone, and water. To increase the electrode density, compression may be performed after the drying.

As the order of forming the active material layer on the surface of the current collector, the negative electrode active material layer is provided and then the positive electrode active material layer may be provided, or the layers may be provided in the opposite order. The negative electrode active material layer and the positive electrode active material layer may be simultaneously provided. That is, the active material layer forming step (step 2) is not limited as long as the step includes: the step of forming the negative electrode active material layer on the first surface of the current collector (step 2a); and the step of providing the positive electrode active material layer on the second surface of the current collector (step 2b), and the order is not limited.

### Metal Hydride Battery and Production Method Therefor

A metal hydride battery of the present disclosure is characterized in that the bipolar electrodes of the present disclosure are stacked. For other configurations, the configuration disclosed in literature such as Japanese Laid-Open Patent Publication No. 2020-140773 can be applied, for example. That is, the metal hydride battery of the present disclosure includes the bipolar electrode including the negative electrode active material layer on the first surface of the current collector, and includes the positive electrode active material layer on the second surface. The current collector includes: the steel sheet; and the Ni—Fe alloy layer provided on at least one surface of the steel sheet, as noted above. In the metal hydride battery of the present disclosure, the number of the bipolar electrodes is one or more, and the number of the bipolar electrodes may be increased or decreased according to the desired capacity. The metal hydride battery of the present disclosure is manufactured by providing a separator between the bipolar electrodes and by performing airtight sealing after injecting the electrolytic solution. The metal hydride battery of the present disclosure is a nickel metal hydride battery, for example.

Hereinafter, the metal hydride battery of an embodiment of the present disclosure will be described with an example of the nickel metal hydride battery as an embodiment, but the invention of the metal hydride battery of the present disclosure is not limited thereto.

FIG. 6 is a schematic cross-sectional view illustrating an embodiment of a power storage device. A power storage device 1 includes a module stack 2 having multiple power storage modules 4 stacked, and a binding member 3 that applies a binding load to the module stack 2 in a stacking direction D of the module stack 2.

The module stack 2 includes multiple power storage modules 4 and multiple cooling plates 5. In the present embodiment, three of the power storage modules 4 and four of the cooling plates 5 are alternately stacked so that the cooling plates 5 are positioned on opposite sides of the power storage module 4. Hereinafter, a direction in which the power storage modules 4 are stacked is referred to as a stacking direction D. A direction crossing or perpendicularly intersecting the stacking direction D is referred to as a horizontal direction.

The power storage module 4 is a bipolar metal hydride battery, and has a rectangular shape as viewed from the stacking direction D. In the following description, a nickel metal hydride battery exemplifies the power storage module 4. The power storage modules 4 adjacent to each other in the stacking direction D are electrically connected to each other via the cooling plate 5. In the module stack 2, a negative electrode terminal 6 is connected to the cooling plate 5 positioned on one end in the stacking direction D. A positive electrode terminal 7 is connected to the cooling plate 5 positioned on the other end in the stacking direction D. The negative electrode terminal 6 and the positive electrode terminal 7 are drawn out from edges of the cooling plates 5 in the direction crossing the stacking direction D, for example. The negative electrode terminal 6 and the positive electrode terminal 7 are connected to an external circuit such as a vehicle, which is not illustrated, and the power storage device 1 is charged and discharged by the external circuit. The cooling plate 5 is made of aluminum.

The outermost layer of the module stack 2 (stack outermost layer) in the present embodiment is the cooling plate 5, but the outermost layer of the module stack 2 may be the power storage module 4. In this case, the negative electrode terminal 6 or the positive electrode terminal 7 is connected to the power storage module 4 forming the stack outermost layer.

Inside the cooling plate 5, multiple channels 5a through which a refrigerant, such as air, flows are provided to release heat generated in the power storage module 4 toward an outside of the power storage device 1. The channels 5a expand along directions crossing (perpendicularly intersecting) the stacking direction D and the drawing direction of the negative electrode terminal 6 and the positive electrode terminal 7, respectively for example. The cooling plate 5 is conductive, and has a function as a connecting member to make electrical connection between the power storage modules 4. The cooling plate 5 allows the refrigerant to flow through these channels 5a to also have a function as a heat dissipating plate of dissipating heat generated in the power storage module 4. In the present embodiment, an area of the cooling plate 5 is smaller than an area of the power storage module 4 in a plane view in the stacking direction D. However, for the improvement of the heat dissipating, the area of the cooling plate 5 may be same as the area of the power storage module 4, or may be larger than the area of the power storage module 4 in a plane in the stacking direction D. Alternatively, a refrigerant at high temperature may flow in the channel 5a to heat the power storage module 4.

The binding member 3 includes two end plates 8 sandwiching the module stack 2 in the stacking direction D, and includes a tightening bolt 81 and a nut 82 to tighten the end plates 8. The end plate 8 is a metal plate that is one size larger than the power storage module 4 and the cooling plate 5 in a plane view in the stacking direction D, and includes a rectangular shape. Between each end plate 8 and the module stack 2, an insulative film F is interposed. The film F insulates each end plate 8 and the module stack 2.

On an edge of the end plate 8, an insertion hole 8a is provided at a position further outward than the module stack 2, as viewed from the stacking direction D. The tightening bolt 81 is inserted from the insertion hole 8a in one end plate 8 toward the insertion hole 8a in the other end plate 8. The nut 82 is screwed with a tip of the tightening bolt 81 protruded from the insertion hole 8a of the other end plate 8. This configuration allows the power storage module 4 and the cooling plate 5 to be sandwiched by two end plates 8 to be unitized as the module stack 2. A binding load is applied to the module stack 2 in the stacking direction D.

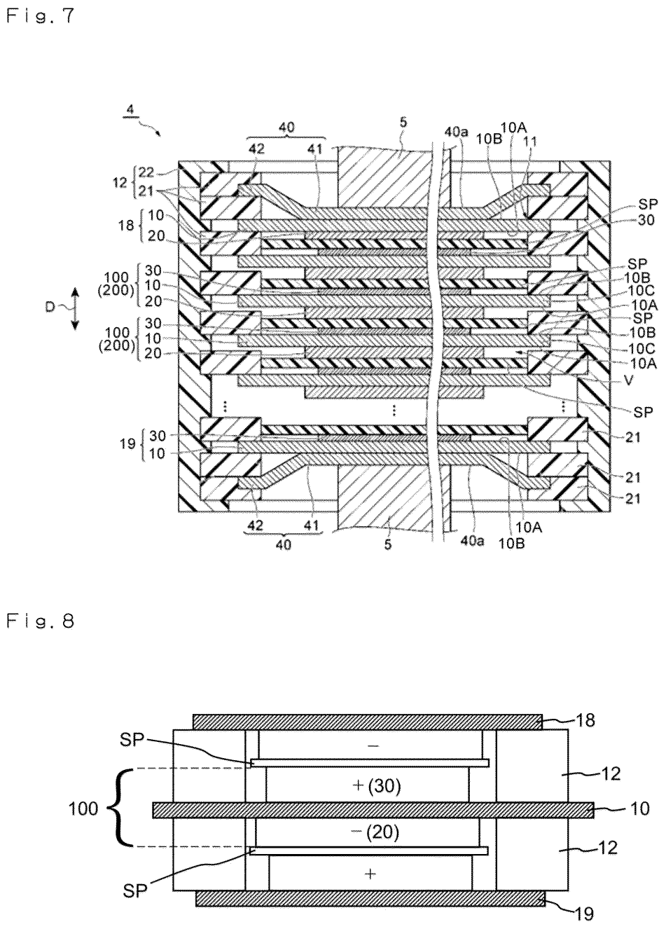

Next, the configuration of the power storage module 4 will be described in detail. FIG. 7 is a schematic cross-sectional view illustrating the internal configuration of the power storage module illustrated in FIG. 6. As illustrated in FIG. 7, the power storage module 4 includes an electrode stack (cell stack) 11, conductive plates 40 positioned on the outer sides of the electrode stack 11 in the stacking direction D; and a sealing portion 12 made of a resin and integrating the electrode stack 11 and the conductive plate 40.

The electrode stack 11 is formed by multiple electrodes stacked via a separator SP in the stacking direction D of the power storage module 4. These electrodes include a stack of multiple bipolar electrodes 100 (200), a negative electrode terminal electrode 18, and a positive electrode terminal electrode 19. The bipolar electrodes 100 (200) and the separator SP have rectangular shapes as viewed from the stacking direction D.

The bipolar electrode 100 (200) includes a current collector 10 having one surface (a first surface) 10A and the other surface (a second surface) 10B opposite to the one surface 10A, a negative electrode active material layer 20 provided on the one surface 10A, and a positive electrode active material layer 30 provided on the other surface 10B. The positive electrode active material layer 30 is formed by applying a positive electrode active material on the current collector 10. The negative electrode active material layer 20 is formed by applying a negative electrode active material on the current collector 10. In the electrode stack 11, the positive electrode active material layer 30 of one bipolar electrode 100 (200) is opposite to the negative electrode active material layer 20 of another bipolar electrode 100 (200) adjacent across the separator SP on one side in the stacking direction D. In the electrode stack 11, the negative electrode active material layer 20 of one bipolar electrode 100 (200) is opposite to the positive electrode active material layer 30 of another bipolar electrode 100 (200) adjacent across the separator SP on the other side in the stacking direction D.

The negative electrode terminal electrode 18 includes the current collector 10 and the negative electrode active material layer 20 provided on the one surface 10A of the current collector 10. The negative electrode terminal electrode 18 is disposed on one end of the electrode stack 11 in the stacking direction D so that the one surface 10A directs toward a central side of the stacking direction D of the electrode stack 11. The other surface 10B of the current collector 10 of the negative electrode terminal electrode 18 forms an outer surface in the stacking direction D of the electrode stack 11, and is electrically connected to one cooling plate 5 adjacent to the power storage module 4 (see FIG. 6) via a conductive plate 40. The negative electrode active material layer 20 in the negative electrode terminal electrode 18 is opposite to the positive electrode active material layer 30 in the bipolar electrode 100 (200) via the separator SP.

The positive electrode terminal electrode 19 includes the current collector 10 and the positive electrode active material layer 30 provided on the other surface 10B of the current collector 10. The positive electrode terminal electrode 19 is disposed on the other end of the electrode stack 11 in the stacking direction D so that the other surface 10B directs toward the central side of the stacking direction D of the electrode stack 11. The positive electrode active material layer 30 in the positive electrode terminal electrode 19 is opposite to the negative electrode active material layer 20 in the bipolar electrode 100 (200) via the separator SP. The one surface 10A of the current collector 10 in the positive electrode terminal electrode 19 forms the outer surface in the stacking direction D of the electrode stack 11, and electrically connected to the other cooling plate 5 adjacent to the power storage module 4 (see FIG. 6) via the conductive plate 40.

The current collector 10 is a steel sheet subjected to a plating treatment. An edge 10C of the current collector 10 is an uncoated region where the positive electrode active material and the negative electrode active material are not applied, and has a rectangular frame shape. As the positive electrode active material forming the positive electrode active material layer 30, the aforementioned material can be used. As the negative electrode active material forming the negative electrode active material layer 20, the aforementioned material can be used. In the present embodiment, a formation region of the negative electrode active material layer 20 on the one surface 10A of the current collector 10 is one size larger than a formation region of the positive electrode active material layer 30 on the other surface 10B of the current collector 10.

The conductive plate 40 is a conductive plate member provided in order to inhibit deterioration of the electrode stack 11. The conductive plate 40 is an uncoated foil in which the active material layer is formed on neither of the opposite surfaces. The conductive plate 40 is made of nickel, for example. The conductive plate 40 includes a central portion 41 in contact with the cooling plate 5, and an edge 42 surrounding the central portion 41 and having a rectangular frame shape. The edge 42 is a portion supported by a sealing body (sealing portion) 12. The thickness of the conductive plate 40 is, for example, 0.1 μm or more and 1000 μm or less. The conductive plate 40 forms an outer wall of the power storage module 4 on the opposite ends in the stacking direction D. When the conductive plate 40 is not provided, the negative electrode terminal electrode 18 and the positive electrode terminal electrode 19 form the outer wall.

The sealing portion 12 is formed with, for example, an insulative resin, and formed as a rectangular frame as its entirety. The sealing portion 12 is provided along a side surface 11a of the electrode stack 11 so as to surround the edge 10C of the current collector 10 and the edge 42 of the conductive plate 40. The sealing portion 12 supports the edge 10C of the current collector 10 and the edge 42 of the conductive plate 40. The sealing portion 12 includes multiple first sealing portions 21 bonded to the edge 10C of the current collector 10 and the edge 42 of the conductive plate 40, and a second sealing portion 22 surrounding the first sealing portion 21 along the side surface 11a from an outside thereof and bonded to each of the first sealing portions 21. Constituent materials of the first sealing portion 21 and the second sealing portion 22 are polypropylene, for example.

The first sealing portion 21 is continuously provided on an entire periphery of the edge 42 of the conductive plate 40 or on an entire periphery of the edge 10C of the other surface 10B of the current collector 10, and has a rectangular frame shape as viewed from the stacking direction D. In the negative electrode terminal electrode 18 and the positive electrode terminal electrode 19, the first sealing portion 21 is provided on the edges 10C of the one surface 10A and the other surface 10B of the current collector 10.

The first sealing portion 21 is welded with the edge 42 of the conductive plate 40 or the other surface 10B of the current collector 10 by ultrasonic or thermocompression, for example, and air-tightly bonded. The first sealing portion 21 is, for example, a film having a predetermined thickness in the stacking direction D. The first sealing portion 21 may be formed by punching a resin sheet, may be formed by disposing a plurality of resin sheets as a frame, or may be formed by injection molding using a mold. In the present embodiment, the first sealing portion 21 is formed by punching a resin sheet. The thickness of the first sealing portion 21 is, for example, 50 μm or more and 250 μm or less. An inside of the first sealing portion 21 is positioned between the edges 10C of the current collector 10 adjacent to each other in the stacking direction D. An outside of the first sealing portion 21 is protruded more outward than the edge of the current collector 10, and a tip thereof is supported by the second sealing portion 22. The first sealing portions 21 adjacent to each other along the stacking direction D may be distanced from or contacted with each other. The outer edges of the first sealing portions 21 may be bonded to each other by, for example, hot-plate welding.

The second sealing portion 22 is provided on the outside of the electrode stack 11 and the first sealing portion 21, and forms the outer wall (housing) of the power storage module 4. The second sealing portion 22 is formed by, for example, injection molding with a resin, and expands over an entire length of the electrode stack 11 along the stacking direction D. The second sealing portion 22 expands along the stacking direction D as an axial direction and having a rectangular frame shape. The second sealing portion 22 is welded with the outer surface of the first sealing portion 21 by heat during the injection molding, for example.

The first sealing portion 21 and the second sealing portion 22 form an internal space V between the adjacent electrodes, and seal the internal space V. In more specific terms, the second sealing portion 22 together with the first sealing portion 21 provides a seal between the bipolar electrodes 100 (200) adjacent to each other along the stacking direction D a seal between the negative electrode terminal electrode 18 and the bipolar electrode 100 (200) adjacent to each other along the stacking direction D, and a seal between the positive electrode terminal electrode 19 and the bipolar electrode 100 (200) adjacent to each other along the stacking direction D. This configuration forms the air-tightly separated internal spaces V between the adjacent bipolar electrodes 100 (200), between the negative electrode terminal electrode 18 and the bipolar electrode 100 (200), and between the positive electrode terminal electrode 19 and the bipolar electrode 100 (200). This internal space V contains the electrolytic solution (not illustrated). The separator SP, the positive electrode active material layer 30, and the negative electrode active material layer 20 are impregnated with the electrolytic solution.

The bipolar electrode 100 (200) and the sealing portion 12 adjacent to each other in the stacking direction D; the bipolar electrode 100 (200) adjacent to the negative electrode terminal electrode 18 and the sealing portion 12; and the bipolar electrode 100 (200) adjacent to the positive electrode terminal electrode 19 and the sealing portion 12; each form a cell (unit battery).

Next, an example of a method for producing the power storage module according to the present embodiment will be described. First, the first sealing portions 21 are bonded to the bipolar electrode 100 (200), the negative electrode terminal electrode 18, the positive electrode terminal electrode 19, and the conductive plate 40 (the first step). In the first step, the bipolar electrode 100 (200), the negative electrode terminal electrode 18, the positive electrode terminal electrode 19, and the conductive plate 40 are firstly prepared. Then, the first sealing portions 21 are welded with the other surface 10B of the current collector 10 and the one surface 40a of the conductive plate 40. This welding bonds the first sealing portion 21 to each of the bipolar electrode 100 (200), the negative electrode terminal electrode 18, the positive electrode terminal electrode 19, and the conductive plate 40. Furthermore, the first sealing portion 21 is also welded with the one surface 10A of the current collector 10 in the positive electrode terminal electrode 19.

Then, the electrode stack 11 is formed (the second step). In the second step, the bipolar electrode 100 (200) bonded to the first sealing portion 21 and the separator SP are firstly alternately stacked along the stacking direction D to form a stack S. Subsequently, the negative electrode terminal electrode 18 is disposed on one end of the stack S in the stacking direction D, and the positive electrode terminal electrode 19 is disposed on the other end of the stack S in the stacking direction D. This disposition forms the electrode stack 11 including the bipolar electrode 100 (200), the separator SP, the negative electrode terminal electrode 18, and the positive electrode terminal electrode 19. At this time, the stacked first sealing portions 21 form the internal space V between the electrodes included in the electrode stack 11, and seal the internal space V.

Thereafter, the conductive plate 40, bonded to the first sealing portion 21, is overlaid on the electrode stack 11 (the third step). In the third step, the first sealing portion 21, bonded to the conductive plate 40, is disposed adjacent to the negative electrode terminal electrode 18 and the positive electrode terminal electrode 19 in the stacking direction D.

Then, the second sealing portion 22 bonding to each of the first sealing portions 21 is formed (the fourth step). In the fourth step, a resin is injection-molded to the outer periphery of each of the first sealing portions 21 by using a mold, for example. The resin is then cured by cooling or the like to form the second sealing portion 22. This step forms the sealing portion 12 including the first sealing portion 21 and the second sealing portion 22. At this time, the conductive plate 40 may be welded with each of the first sealing portions 21 bonded to the negative electrode terminal electrode 18 or the positive electrode terminal electrode 19. Although not illustrated, the electrolytic solution is injected into each of the internal spaces V after the fourth step. The power storage module 4 is produced via the above steps.

The nickel metal hydride battery of the present embodiment preferably includes various types of members that are used in a known nickel metal hydride battery. Hereinafter, the battery unit composed of the positive electrode terminal electrode, the bipolar electrode, the negative electrode terminal electrode, and the separator is referred to as the battery module. The nickel metal hydride battery of the present disclosure may include a single battery module, or may include multiple battery modules in combination in series.

Known separators may be adopted as the separator. For example, the separator may be composed of: synthetic resins such as polytetrafluoroethylene, polypropylene, polyethylene, a polyimide, a polyamide, a polyaramid (aromatic polyamide), a polyester, and polyacrylonitrile; polysaccharides such as cellulose and amylose; natural polymers such as fibroin, keratin, lignin, and suberin; a porous material using one or more electrically insulative materials such as ceramic; nonwoven fabric; and woven fabric. The separator may have a multilayer structure. A surface of the separator is preferably subjected to a hydrophilization treatment. Examples of the hydrophilization treatment include a sulfonation treatment, a corona treatment, a fluorine-gas treatment, and a plasma treatment.

As the electrolytic solution, a strongly basic aqueous solution commonly used as an electrolytic solution for the nickel metal hydride battery may be used. Specific examples of the strongly basic aqueous solution include a potassium hydroxide aqueous solution, a sodium hydroxide aqueous solution, and a lithium hydroxide aqueous solution. As the electrolytic solution, only one type of the strongly basic aqueous solution may be used, or multiple types of the strongly basic aqueous solution may be mixed to use. A known additive adopted for an electrolytic solution for the nickel metal hydride battery may be added to the electrolytic solution.

The sealing portion is provided between the electrodes of the nickel metal hydride battery of the present disclosure. The sealing portion prevents leakage of the electrolytic solution, inhibits mutually mixing of the electrolytic solution between the electrodes, and inhibits contact of the electrolytic solution, the positive electrode active material layer, and the negative electrode active material layer with open air. The sealing portion is disposed in close contact with the adjacent two current collectors, and disposed in a state of surrounding an entirety of the portion where the electrolytic solution, the positive electrode active material layer, and the negative electrode active material layer are present. The sealing portion may be disposed doubly or triply around the portion where the electrolytic solution, the positive electrode active material layer, and the negative electrode active material layer are present.

Examples of a material of the sealing portion include an insulative resin having alkali resistance such as polypropylene, polyphenylene sulfide, and modified polyphenylene ether. A member, commonly called a gasket or a packing, may be adopted as the sealing portion. The sealing portion may be formed by crimping the material of the sealing portion with the current collector, may be formed by thermocompression with the current collector, or may be formed by adhering to the current collector using an adhesive.

An insulative outer frame that does not conduct electricity is preferably disposed on the periphery of the electrode. The outer frame has a role of keeping the shape of the electrode and a role of preventing a short circuit between the electrodes. The aforementioned sealing portion is disposed inside the outer frame. The outer frame may also serve as the sealing portion. Examples of a material of the outer frame include: synthetic resins; or synthetic resins containing an insulative oxide or an insulative ceramic.

The nickel metal hydride battery of the present disclosure preferably includes a cooling plate dissipating heat generated with charge and discharge. The cooling plate is preferably disposed outside the battery module along the surface of the electrode. When multiple battery modules are present, the cooling plates may be each disposed between the battery modules.

The cooling plate is preferably made of metal having excellent thermal conductivity, such as aluminum. The shape of the cooling plate is preferably a plate body that can be stacked on the surface of the battery module, and more preferably a plate body in which a through hole enabling air-cooling is provided.

The battery module of the nickel metal hydride battery of the present disclosure is preferably bound in the thickness direction, namely the stacking direction of the electrode, by a binding tool. Binding the battery module in the stacking direction enables the electrolytic solution to be uniformly permeated in the positive electrode active material layer and the negative electrode active material layer. The binding also inhibits unevenness of expansion of the electrode with charge and discharge, and inhibits changes in resistance of the battery. The binding also keeps the sealing effect of the sealing portion in a favorable manner.

The binding member may bind one battery module, or may bind multiple battery modules. As the binding member, two binding plates and a tightening member to tighten the two binding plates are preferably used. Examples of the tightening member include a bolt and nut. A material of the binding member preferably has high resistance against a strong alkali. Specific examples of the material of the binding member include synthetic resins and insulative ceramics. A battery case housing the battery module may be used as the binding member.

The battery case is a case housing the battery module. As the battery case, those used as a known battery case for a metal hydride battery may be adopted. The shape of the battery case is not particularly limited, and various shapes such as a rectangular shape, a cylindrical shape, a coin shape, and a laminate shape can be adopted. A material of the battery case preferably has high resistance against a strong alkali. Specific examples of the battery case include a case made of nickel, a case made of a resin, a metal case with a nickel-plated inner surface, and a metal case including a resin-coated layer on an inner surface.

On the binding member or the battery case, a gas-discharging vent may be disposed, and an injection port for refilling the electrolytic solution may be disposed.

The nickel metal hydride battery of the present disclosure may be mounted on vehicles and industrial vehicles. The vehicle is a vehicle using electric energy with the nickel metal hydride battery for all or a part of its power source, and the vehicle is preferably an electric vehicle or a hybrid vehicle, for example. When the nickel metal hydride battery is mounted on the vehicle, multiple nickel metal hydride batteries are preferably connected in series to form a battery pack. Examples of a device on which the nickel metal hydride battery is mounted include, in addition to a vehicle, various battery-driven home electric appliances, office equipment, and industrial equipment such as a personal computer and a mobile telecommunication device. Furthermore, the nickel metal hydride battery of the present disclosure may be used for: a power storage device and power smoothing device of wind power generation, solar power generation, water power generation, and other power systems; a power supplying source of power and/or an auxiliary machine for a watercraft or the like; a power supplying source of power and/or an auxiliary machine for an aircraft, a spaceship, or the like: an auxiliary power source for a vehicle not using electricity as its power source; a power source of a mobile domestic robot; a power source for system back-up; a power source for an uninterruptible power supply; and a power storage device to temporarily store power needed for charge in a charge station for an electric vehicle, and the like.

The above-described embodiments may be modified or improved by a person skilled in the art. The above-described embodiments may be modified as follows. The above-described embodiments and the following modifications can be combined as long as the combined modifications remain technically consistent with each other.

The Ni—Fe alloy layers 15 are formed on the opposite surfaces of the current collector 10, which forms the bipolar electrode 100 (200), the negative electrode terminal electrode 18, and the positive electrode terminal electrode 19 in the above embodiment, but may be formed on only one surface of the current collector 10. When the Ni—Fe alloy layer 15 is provided on one surface of the current collector 10, the Ni—Fe alloy layer 15 is preferably provided on the one surface (first surface) 10A. The Ni—Fe alloy layer 15 is not necessarily required to be provided on the current collector 10, which forms the positive electrode terminal electrode 19.

The other surface 10B of the current collector 10 included in the bipolar electrode is roughened in the above embodiment, but the configuration is not limited thereto. For example, only a portion included in the bonding region to the first sealing portion 21 in the other surface 10B may be roughened. In the one surface 40a of the conductive plate 40, only a portion included in the bonding region to the first sealing portion 21 may be roughened.

Each of the current collector and the conductive plate has the rectangular shape in a plane view in the above embodiment, but the configuration is not limited thereto. Each of the current collector and the conductive plate may have a polygonal shape, a circular shape, or an oval shape in a plane view. Similarly, each of the end plate, the separator, and the sealing portion (specifically, the first sealing portion and the second sealing portion) is not necessarily required to have the rectangular frame shape in a plane view.

### EXAMPLES

Hereinafter, Examples to which the above embodiments are further specified will be described. The above embodiments are not limited by these Examples.

### Example 1

### Production of Current Collector

First, a cold rolled foil (thickness: 50 μm) of a low-carbon aluminum killed steel having the following chemical composition was prepared as a steel sheet.

C: 0.04% by weight, Mn: 0.32% by weight, Si: 0.01% by weight, P: 0.012% by weight, S: 0.014% by weight, the remainder: Fe and inevitable impurities

Then, the prepared steel sheet was subjected to electrolytic degreasing and acid pickling with immersion in sulfuric acid, and then Ni was plated on the opposite surfaces of the steel sheet under the following conditions with a target thickness of 0.35 μm on one surface by using a watt bath. This plating formed a Ni-plating layer with a Ni coating mass of 3.12 g/m² on each of the opposite surfaces of the steel sheet (a first Ni-plating step). The conditions of the Ni plating were as follows.

### Conditions for First Ni Plating

Bath composition: nickel sulfate hexahydrate: 250 g/L, nickel chloride hexahydrate: 45 g/L, boric acid: 30 g/L
Bath temperature: 60° C.
pH: 4.0 to 5.0
Stirring: air stirring or jet stirring
Current density: 10 A/dm²

Subsequently, the steel sheet including the Ni-plating layer formed as above was subjected to a heating treatment (diffusion step) by box annealing under conditions of a heating treatment temperature of 560° C., a soaking time of 6 hours, and a reductive atmosphere. This heating treatment yielded a surface-treated steel sheet in which Ni—Fe alloy layers were formed on the opposite surfaces of the steel sheet. The thickness of the Ni—Fe alloy layer on one surface of the obtained surface-treated steel sheet was 1.2 μm.

The thickness of the Ni—Fe alloy layer was obtained by using SEM-EDX (energy dispersive X-ray spectrometry). That is, the thickness of the Ni—Fe alloy layer was calculated by elemental analysis with SEM-EDX (energy dispersive X-ray spectrometry) of Ni and Fe with linear analysis in a portion from a surface layer to a depth of 10 μm in a thickness direction. The measurement conditions were as follows: acceleration voltage: 10 KV, observation magnification: 5000, measurement step: 0.01 μm. As shown in FIG. 2, read as the thickness of the Ni—Fe alloy layer from a graph is a distance between a 1/10 point of the maximum value of Ni and a 1/10 point of the maximum value of Fe in a portion near a crossing point of a Ni curve and a Fe curve with setting the distance (μm) in the depth direction from the surface layer as the horizontal axis and X-ray intensities of Ni and Fe as the vertical axis.

Then, base Ni layers with a thickness of 1.0 μm were formed under the following plating conditions on the opposite surfaces of the surface-treated steel sheet in which the Ni—Fe alloy layers were formed on the opposite surfaces (a second Ni-plating step).

### Conditions for Base Ni Layer Plating

Bath composition: nickel sulfate hexahydrate: 250 g/L, nickel chloride hexahydrate: 45 g/L, boric acid: 30 g/L
pH: 4.0 to 5.0
Bath temperature: 60° C.
Current density: 10 A/dm²

On the other surface (a second surface) of the surface-treated steel sheet with the formed base Ni layer, a roughened Ni layer was provided under the following plating conditions (a third Ni-plating step) to obtain a current collector. After the plating step under the following conditions for the roughened Ni layer plating, the roughened Ni layer was formed by Ni-plating coating treatment under the following conditions for the Ni-plating coating in order to improve adhesiveness between the steel sheet and the roughened Ni layer. A nickel coating mass as the roughened Ni layer was 18.1 g/m².

### Conditions for Roughened Ni Layer Plating

Concentration of nickel sulfate hexahydrate in plating bath: 10 g/L
Concentration of nickel chloride hexahydrate in plating bath: 10 g/L
Concentration of chloride ion in plating bath: 3 g/L
Ratio between nickel ion and ammonium ion in plating bath: nickel ion/ammonium ion (weight ratio)=0.17
pH: 6
Bath temperature: 50° C.
Current density: 12 A/dm²
Plating time: 80 seconds

### Conditions for Ni-Plating Coating

Bath composition: 250 g/L of nickel sulfate hexahydrate, 45 g/L of nickel chloride hexahydrate, and 30 g/L of boric acid
pH: 4.2
Bath temperature: 60° C.
Current density: 5A/dm²
Plating time: 36 seconds

That is, the current collector of Example 1 produced as above had the Ni—Fe alloy layer, the base Ni layer, and the roughened Ni layer in this order from the surface side of the steel sheet. The steel sheet was a substrate of the current collector. The Ni—Fe alloy layers and the base Ni layers were formed on the opposite surfaces (the first surface and the second surface) of the current collector. The roughened Ni layer was formed only on the other surface (the second surface) of the current collector.

### Production of Bipolar Electrode

94.3 parts by mass of a nickel hydroxide powder as a positive electrode active material, 1 part by mass of a cobalt powder as a conductive aid, 3.5 parts by mass in terms of solid content of an acrylic resin emulsion as a binder, 0.7 parts by mass of carboxymethylcellulose as a binder, 0.5 parts by mass of Y₂O₃ as a positive electrode additive, and an appropriate amount of ion-exchanged water were mixed to produce a positive electrode slurry.

97.8 parts by mass of an A₂B₇-type hydrogen storage alloy as a negative electrode active material, 1.5 parts by mass in terms of solid content of an acrylic resin emulsion as a binder, 0.7 parts by mass of carboxymethylcellulose as a binder, and an appropriate amount of ion-exchanged water were mixed to produce a negative electrode slurry.

The negative electrode slurry was applied on the first surface of the current collector to form a film. The positive electrode slurry was applied on the second surface of the current collector to form a film. The current collector with the applied slurries was dried for removing water, and pressed to produce a bipolar electrode in which a positive electrode active material layer and a negative electrode active material layer were formed on the current collector.

A positive electrode terminal electrode in which a positive electrode active material layer was formed on the second surface was produced in the same manner as for the above bipolar electrode except that the negative electrode slurry was not applied on the first surface of the current collector. A negative electrode terminal electrode in which a negative electrode active material layer was formed on the first surface was produced in the same manner as for the above bipolar electrode except that the positive electrode slurry was not applied on the second surface of the current collector.

### Production of Battery for Evaluation

A battery for evaluation having a configuration illustrated in the schematic diagram of FIG. 8 was produced.

As an electrolytic solution, prepared was an aqueous solution having a potassium hydroxide concentration of 5.4 mol/L, a sodium hydroxide concentration of 0.8 mol/L, a lithium hydroxide concentration of 0.5 mol/L, and a lithium chloride concentration of 0.05 mol/L.

As a separator SP, a nonwoven fabric with a thickness of 104 μm made of a polyolefin fiber subjected to a sulfonation treatment was prepared. The bipolar electrode 100 was sandwiched between the positive electrode terminal electrode 19 and the negative electrode terminal electrode 18 to form an electrode plate group. The separator SP was interposed between the electrodes.

A housing (sealing portion) 12 made of a resin was disposed between the bipolar electrode 100 and the positive electrode terminal electrode 19, and between the bipolar electrode 100 and the negative electrode terminal electrode 18, and these materials were bonded by thermocompression. The electrolytic solution was injected between the bipolar electrode 100 and the positive electrode terminal electrode 19 and between the bipolar electrode 100 and the negative electrode terminal electrode 18, and then these materials were air-tightly sealed to produce the battery for evaluation of Example 1. In this Example, the bipolar electrode 100 and the positive electrode terminal electrode 19 formed one cell (unit battery), and the bipolar electrode 100 and the negative electrode terminal electrode 18 formed one cell (unit battery). The battery for evaluation had the two cells in total.

### Example 2

In the step of producing the current collector, the target thickness in the first Ni—plating step was 0.5 μm. The heating treatment was performed in the subsequent diffusing step. This heating treatment yielded a surface-treated steel sheet in which the Ni—Fe alloy layers were formed on the opposite surfaces of the steel sheet. The thickness of the Ni—Fe alloy layer on one surface of the obtained surface-treated steel sheet was 1.5 μm. A current collector, a bipolar electrode, and a battery for evaluation were produced in the same manner as in Example 1 except for the above.

### Example 3

In the step of producing the current collector, the target thickness in the first Ni—plating step was 1.5 μm. The heating treatment was performed in the subsequent diffusing step. This heating treatment yielded a surface-treated steel sheet in which the Ni—Fe alloy layers were formed on the opposite surfaces of the steel sheet. The thickness of the Ni—Fe alloy layer on one surface of the obtained surface-treated steel sheet was 2.5 μm. A current collector, a bipolar electrode, and a battery for evaluation were produced in the same manner as in Example 1 except for the above.

### Example 4

In the step of producing the current collector, the target thickness in the first Ni—plating step was 3.0 μm. The heating treatment was performed at a heating treatment temperature of 640° C. and a soaking time of 2 hours in the subsequent diffusing step. This heating treatment yielded a surface-treated steel sheet in which the Ni—Fe alloy layers were formed on the opposite surfaces of the steel sheet. The thickness of the Ni—Fe alloy layer on one surface of the obtained surface-treated steel sheet was 3.87 μm. A current collector, a bipolar electrode, and a battery for evaluation were produced in the same manner as in Example 1 except for the above.

### Example 5

First, low-carbon aluminum killed steel with a thickness of 200 μm was prepared as a steel sheet, and plated with Ni by using a watt bath with a target thickness of 2.0 μm (the first Ni-plating step). Then, softening heating treatment was performed for rolling, and the then steel sheet was rolled to 50 μm. Thereafter, a heating treatment (diffusing step) was performed at a heating treatment temperature of 480° C. and a soaking time of 4 hours under a condition of a reductive atmosphere. This heating treatment yielded a surface-treated steel sheet having the Ni—Fe alloy layers on the opposite surfaces. The thickness of the Ni—Fe alloy layer on one surface of the obtained surface-treated steel sheet was 0.55 μm. A current collector, a bipolar electrode, and a battery for evaluation were produced in the same manner as in Example 1 except for the above.

### Comparative Example 1

The steel sheet used in Example 1 was subjected to the second Ni-plating step and the third Ni-plating step in the same manner as in Example 1 to produce a current collector in which the base Ni layer and the roughened Ni layer were provided. The thickness of the base Ni layer was 1 μm. The first Ni-plating step and the heating treatment for providing the Ni—Fe alloy layer were not performed. A bipolar electrode and a battery for evaluation were produced in the same manner as in Example 1 except that the current collector was changed to the above current collector.

### Comparative Example 2

The steel sheet used in Example 1 was subjected to the second Ni-plating step and the third Ni-plating step in the same manner as in Example 1 to produce a current collector in which the base Ni layer and the roughened Ni layer were provided. The thickness of the base Ni layer was 5 μm. The first Ni-plating step and the heating treatment for providing the Ni—Fe alloy layer were not performed. A bipolar electrode and a battery for evaluation were produced in the same manner as in Example 1 except that the current collector was changed to the above current collector.

### Test on Change in Leakage Current With Presence/Absence and Change in Thickness of Ni—Fe Alloy Layer

By using the battery for evaluation produced as above, a change in a leakage current with presence/absence and a change in the thickness of the Ni—Fe alloy layer in the current collector was tested and evaluated.

Specifically, each of the batteries for evaluation of the above Examples 1 to 5 and Comparative Examples 1 and 2 was repeatedly charged and discharged to perform an activating treatment.

Each of the batteries for evaluation after the activation was adjusted to have state of charge (SOC) 85%, and then discharged until SOC 0% to measure a discharge capacity before storage. Each of the batteries for evaluation after the activation was adjusted again to have SOC 85%, and stored in a thermostat bath at 65° C. for 350 hours. Each of the batteries for evaluation after the storage was discharged until SOC 0% to measure a discharge capacity after the storage. A leakage current was calculated by the following formula.

(Discharge capacity before storage−Discharge capacity after storage)/Storage time=Leakage current

Table 1 shows each value of the leakage current per unit area.

Comparing Comparative Examples with Example 5 demonstrated a reduction in the leakage current thanks to the Ni—Fe alloy layer. Examples 1 to 5 demonstrated that increasing the thickness of the Ni—Fe alloy layer is effective to reduce the leakage current. Meanwhile, the thickness of the Ni—Fe alloy layer was changed from 1.2 μm to 1.5 μm, but the leakage current value does not change in Examples 1 and 2. Thus, it is considered that the thickness of the Ni—Fe alloy layer of 1.0 μm is a value sufficient for reducing the leakage current.

Each of the batteries for evaluation of Examples 2 to 4 after activation and Comparative Example 1 was repeatedly subjected to a charge-discharge cycle of charge under a condition of 60° C. at 1 C from SOC 20% until SOC 80% and then discharge at 1 C from SOC 80% until SOC 20% with 1500 times. Thereafter, the battery was charged until SOC 80% and then each cell was independently discharged at 1 C from SOC 80% until SOC 0% to measure a discharge capacity of each cell after the cycles. The leakage current was calculated by the following formula. The test time was a time required for the charge and discharge 1500 times. The cell composed of the bipolar electrode and the positive electrode terminal electrode is specified as a cell on a hydrogen generation side, and the cell composed of the bipolar electrode and the negative electrode terminal electrode is specified as a cell on a hydrogen penetration side.

(Discharge capacity of cell on hydrogen generation side−Discharge capacity of cell on hydrogen penetration side)/Test time=Leakage current

TABLE 1

| | Thickness of | Leakage current upon | Leakage current |
|---|---|---|---|
| | Ni—Fe | storage at SOC 85%, | at 1500 cycles |
| | alloy layer | 65° C. for 350 hours | at 60° C. |
| | (μm) | (μA/m²) | (μA/m²) |
| Example 1 | 1.2 | 25.2 | unmeasured |
| Example 2 | 1.5 | 25.2 | 4.2 |
| Example 3 | 2.5 | 16.8 | 21 |
| Example 4 | 3.87 | 0 | 16.8 |
| Example 5 | 0.55 | 575.6 | 142.9 |
| Comparative | 0 | 19200 | 239.5 |
| Example 1 | | | |
| Comparative | 0 | 14280 | unmeasured |
| Example 2 | | | |

The battery for evaluation of the above Example 2 was evaluated at a low temperature of −40° C. as follows. After the activation, the battery for evaluation was adjusted to have state of charge (SOC) 85%, and then discharged until SOC 0% to measure a discharge capacity before storage. The batteries for evaluation after the activation were adjusted again to have a SOC of 85%, and then stored in a thermostat bath at −40° C. for 350 hours. The batteries for evaluation after the storage were discharge until the SOC was 0% to measure a discharge capacity after the storage. The leakage current was calculated by the following formula.

(Discharge capacity before storage−Discharge capacity after storage)/Storage time=Leakage current

A value of the leakage current per unit area was 0.0 μm/m²

### Leakage Current Test With Power Storage Module

### Example 6

A current collector and a bipolar electrode were produced in the same manner as in Example 2. Thereafter, a power storage module as illustrated in FIG. 6 was produced by using a separator, an active material, and the like that were same as in the aforementioned battery for evaluation. This power storage module had terminal electrodes of the positive electrode and the negative electrode in addition to the bipolar electrode including a stacking number of 23.

The obtained power storage module was repeatedly charged and discharged to perform an activating treatment.

The power storage module after the activation was adjusted to have a state of charge (SOC) of 85%, and then discharged until the SOC was 0% to measure a discharge capacity before storage. The power storage module after the activation was adjusted again to have a SOC of 85%, and stored in a thermostat bath at 65° C. for 170 hours. The power storage module after the storage was discharged until SOC 0% to measure a discharge capacity after the storage. A leakage current was calculated by the following formula.

(Discharge capacity before storage−Discharge capacity after storage)/Storage time=Leakage current

Table 2 shows the leakage current per unit area.

### Comparative Example 3

A power storage module was produced in the same manner as in Example 6 except that, in the current collector forming step, the Ni-plating (the first Ni-plating step) and the heating treatment (diffusing step) for providing the Ni—Fe alloy layer were not performed. A leakage current of the obtained power storage module was calculated in the same manner as in Example 6. Table 2 shows the obtained leakage current per unit area.

TABLE 2

| | Thickness of | Leakage current upon |
|---|---|---|
| | Ni—Fe | storage at SOC 85%, |
| | alloy layer | 65° C. for 170 hours |
| | (μm) | (μA/m²) |
| Example 6 | 1.5 | 8.5 |
| Comparative | 0 | 20312.8 |
| Example 3 | | |

The operational advantages exhibited by the bipolar electrode according to the present embodiment and the power storage module, which has been described above, will be described. The bipolar electrode and the power storage module in the present embodiment reduce voltage drop of the power storage module by reducing hydrogen permeating the current collector in the bipolar electrode. Therefore, the embodiment of the present disclosure improves long-term reliability of the power storage module and the metal hydride battery.

1. A bipolar electrode for a metal hydride battery, the bipolar electrode comprising:
a current collector including a first surface and a second surface opposite to the first surface;
a negative electrode active material layer provided on the first surface; and
a positive electrode active material layer provided on the second surface, wherein
the negative electrode active material layer contains a metal hydride, and
the current collector includes a steel sheet and a Ni—Fe alloy layer formed on at least one surface of opposite surfaces of the steel sheet.

2. The bipolar electrode for a metal hydride battery according to claim 1, wherein the Ni—Fe alloy layer has a thickness of 1.0 μm or more.

3. The bipolar electrode for a metal hydride battery according to claim 1, wherein the Ni—Fe alloy layer is disposed on a same side as the first surface of the current collector.

4. The bipolar electrode for a metal hydride battery according to claim 1, wherein the Ni—Fe alloy layer is disposed on each of a same side as the first surface of the current collector and a same side as the second surface of the current collector.

5. The bipolar electrode for a metal hydride battery according to claim 1, wherein the current collector further includes a Ni layer between the Ni—Fe alloy layer disposed on a same side as the first surface of the current collector and the negative electrode active material layer.

6. The bipolar electrode for a metal hydride battery according to claim 1, wherein the current collector further includes a Ni layer between the Ni—Fe alloy layer disposed on a same side as the second surface of the current collector and the positive electrode active material layer.

7. The bipolar electrode for a metal hydride battery according to claim 5, wherein a surface of the Ni layer that is in contact with the negative electrode active material layer or with the positive electrode active material layer has a larger surface roughness than the Ni—Fe alloy layer or the steel sheet.

8. The bipolar electrode for a metal hydride battery according to claim 7, wherein, when expressed in a ten point height of irregularities Rzjis, the surface roughness of the Ni layer is in a range of 2.0 μm to 16.0 μm.

9. A metal hydride battery, comprising multiple bipolar electrodes stacked, wherein each of the bipolar electrodes is the bipolar electrode according to claim 1.

10. The metal hydride battery according to claim 9, wherein the positive electrode active material layer contains nickel hydroxide.

11. A method for producing a bipolar electrode for a metal hydride battery, the method comprising:
a step of forming a current collector including a steel sheet and a Ni—Fe alloy layer, including
providing a Ni layer on at least one of opposite surfaces of the steel sheet, and
heat-treating the steel sheet on which the Ni layer is provided to diffuse Ni in the Ni layer and Fe in the steel sheet, thereby forming the Ni—Fe alloy layer;
a step of forming a negative electrode active material layer on a first surface of the formed current collector; and
a step of providing a positive electrode active material layer on a second surface of the current collector.

12. The method for producing a bipolar electrode for a metal hydride battery according to claim 11, wherein the step of forming the current collector further includes forming a roughened Ni layer on the Ni—Fe alloy layer, the roughened Ni layer having a larger surface roughness than the Ni—Fe alloy layer or a larger surface roughness than the steel sheet.

13. A method for producing a metal hydride battery, the method comprising:
a step of producing a bipolar electrode by the production method according to claim 11; and
a step of producing a metal hydride battery by using the bipolar electrode.
